(19) United States
(12) Patent Application Publication
(10) Pub. No.: US 2009/0183671 A1
(43) Pub. Date: Jul. 23, 2009

(54) Color filter fabrication apparatus

(76) Inventors: Sen-Yeu Yang, Taipei (TW); Kuo-Huang Hsieh, Taipei (TW); Jian-Ren Ciou, Taipei (TW); Liang-Ting Jiang, Taipei (TW); Po-Hsun Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,979

(22) Filed: Jan. 14, 2009

(30) Foreign Application Priority Data
Jan. 18, 2008 (TW) 097101962

(51) Int. Cl. B05C 11/00

(52) U.S. Cl. 118/46

(57) ABSTRACT

A color filter fabrication apparatus is disclosed to include a platform carrying a substrate, a black matrix printing roller, a first photoresist printing roller, a second photoresist printing roller and a third photoresist printing roller for printing a black matrix, a first photoresist, a second photoresist and a third photoresist onto the substrate in a proper order, and curing apparatuses for curing the printed black matrix, first photoresist, second photoresist and third photoresist respectively.

### BACKGROUND OF THE INVENTION

The present invention relates to color filter fabrication technology and more specifically, to a color filter fabrication apparatus for making color filters by means of roller printing.

Please refer to FIG. 1. The fabrication of a conventional color filter includes the steps of:

Step 100, where a metal layer 12, for example, a layer of chrome is covered on the surface of a substrate 10;

Step 101, where the metal layer 12 is etched to remove the undesired part, forming a pattern of a black matrix 121 on the surface of the substrate 10;

Step 102, where a layer of red photoresist 14 is coated on the substrate 10 over the black matrix 121:

Step 103, where a photomask 143 is covered on the layer of red photoresist 14 and then ultraviolet light 145 is employed to radiate the layer of red photoresist 14 through the photomask 143, curing the layer of red photoresist 14 partially subject to the configuration of the photomask 143;

Step 104, where the photomask 143 is taken away, and the red photoresist 14 that is not cured is removed from the substrate 10, leaving cured red photoresist 141 on the substrate 10; and

Step 105, where green photoresist 161 and blue photoresist 181 are respectively formed on the substrate 10 and cured in a same manner as the aforesaid Steps 102 through 104.

According to the aforesaid conventional color filter fabrication method, the investment cost of the etching equipment is high. Further, during cleaning after curing of applied red, green or blue photoresist, ⅔ of the applied photoresist is wasted. From the point of view of material utilization, the aforesaid fabrication process is resource-wasting method.

### SUMMARY OF THE PRESENT INVENTION

It is, therefore, the primary purpose of the present invention to provide a color filter fabrication equipment, which utilizes printing rollers having a respective microstructure pattern for printing the desired black matrix and photoresist patterns, achieving the fabrication of color filters rapidly and accurately.

It is another object of the present invention to provide a color filter fabrication equipment, which utilizes printing rollers to print black matrix and red, green and blue photoresist materials, accelerating the fabrication of color filters and lowering the related manufacturing cost.

It is still another object of the present invention to provide a color filter fabrication equipment, which runs curing operation when printing photoresist materials onto the substrate, enhancing the effect of the adherence of the printed photoresist materials to the substrate.

It is still another object of the present invention to provide a color filter fabrication equipment, which utilizes orderly arranged printing rollers to print the desired black matrix and photoresist patterns, achieving continuous fabrication and improving the productivity and yield rate.

It is still another object of the present invention to provide a color filter fabrication equipment, which effectively utilizes applied materials, greatly reducing the consumption of photoresist materials during the manufacturing process.

To achieve these and other objects and according to a first embodiment of the present invention, the color filter fabrication apparatus comprises a platform carrying a substrate, a black matrix printing roller mounted on the platform in a first position and kept in contact with the substrate for printing a black matrix material on the substrate, a first photoresist printing roller mounted on the platform in a second position and kept in contact with the substrate for printing a first photoresist material on the substrate, a second photoresist printing roller mounted on the platform in a third position and kept in contact with the substrate for printing a second photoresist material on the substrate, and a third photoresist printing roller mounted on the platform in a fourth position and kept in contact with the substrate for printing a third photoresist material on the substrate, wherein the first photoresist printing roller, the second photoresist printing roller and the third photoresist printing roller are rotated to print a first photoresist, a second photoresist and a third photoresist onto the substrate in such a manner that the printed first photoresist, second photoresist and third photoresist fill up a respective area defined by the black matrix material being printed on the substrate by the black matrix printing roller.

To achieve these and other objects and according to a second embodiment of the present invention, the color filter fabrication apparatus comprises a platform carrying a substrate, a black matrix printing roller mounted on the platform in a first position and kept in contact with the substrate for printing a black matrix material on the substrate, a first transfer-printing roller mounted on the platform in a second position and kept in contact with the substrate for transfer-printing a first photoresist material on the substrate, a first photoresist printing roller disposed above the first transfer-printing roller for printing a first photoresist material onto the first transfer-printing roller, a second transfer-printing roller mounted on the platform in a third position and kept in contact with the substrate for printing a second photoresist material on the substrate, a second photoresist printing roller disposed above the second transfer-printing roller for printing a second photoresist material onto the second transfer-printing roller, a third transfer-printing roller mounted on the platform in a fourth position and kept in contact with the substrate for printing a third photoresist material on the substrate, and a third photoresist printing roller disposed above the third transfer-printing roller for printing a third photoresist material onto the third transfer-printing roller, wherein the first transfer-printing roller, the second transfer-printing roller and the third transfer-printing roller are rotated to print a first photoresist, a second photoresist and a third photoresist onto the substrate in such a manner that the printed first photoresist, second photoresist and third photoresist fill up a respective area defined by the black matrix material being printed on the substrate by the black matrix printing roller.

### BRIEF DESCRIPTION OF THE DRAWINGS

FIG. 1 is a flow chart showing the fabrication of a color filter according to the prior art.

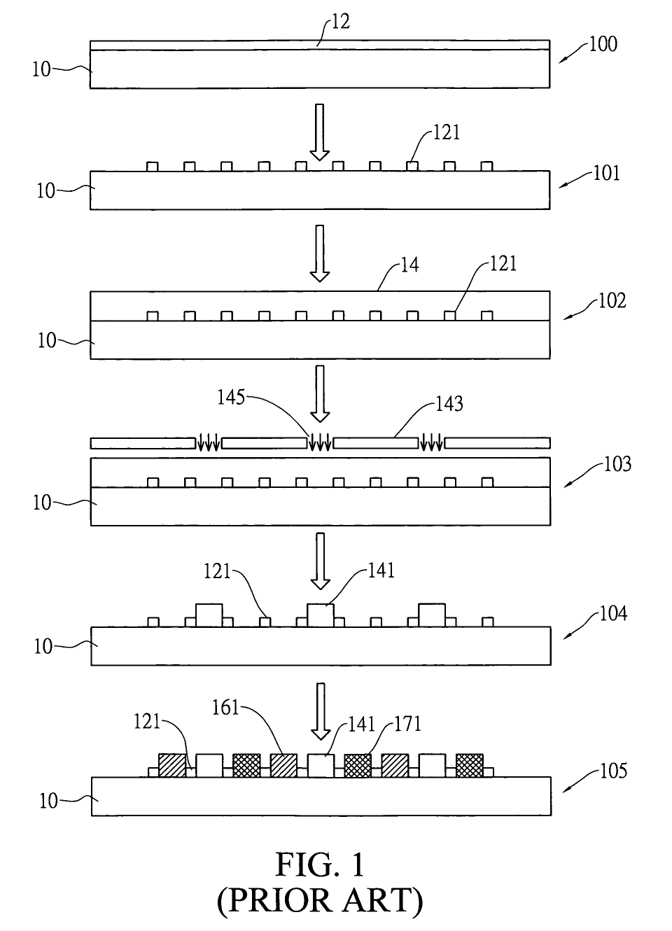

FIG. 2 is a schematic drawing showing the structure of a black matrix printing roller for a color filter fabrication apparatus according to the present invention.

FIG. 3 is a schematic drawing showing the structure of a photoresist printing roller for a color filter fabrication apparatus according to the present invention.

FIG. 4 is a schematic drawing showing the arrangement of a color filter fabrication apparatus according to the present invention.

FIG. 5 is a schematic drawing showing an alternate form of the photoresist printing roller for a color filter fabrication apparatus according to the present invention.

FIG. 6 is a schematic drawing showing an alternate form of the color filter fabrication apparatus according to the present invention.

### DETAILED DESCRIPTION OF THE PREFERRED EMBODIMENTS

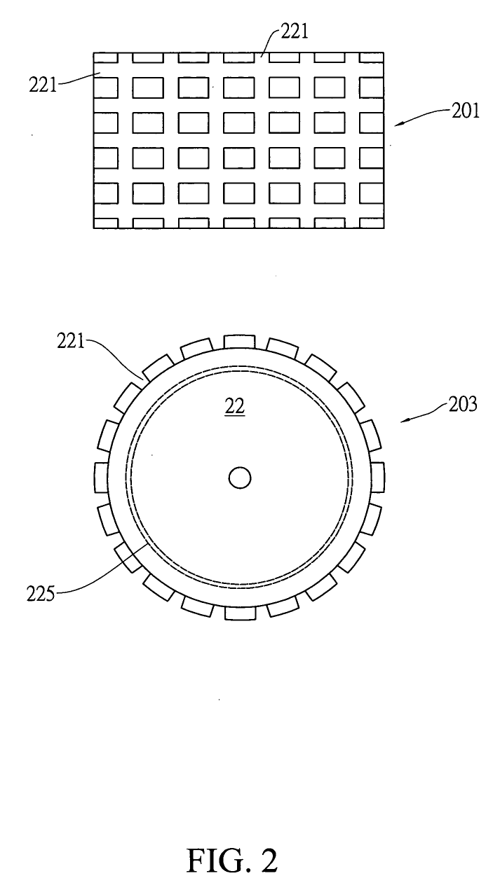

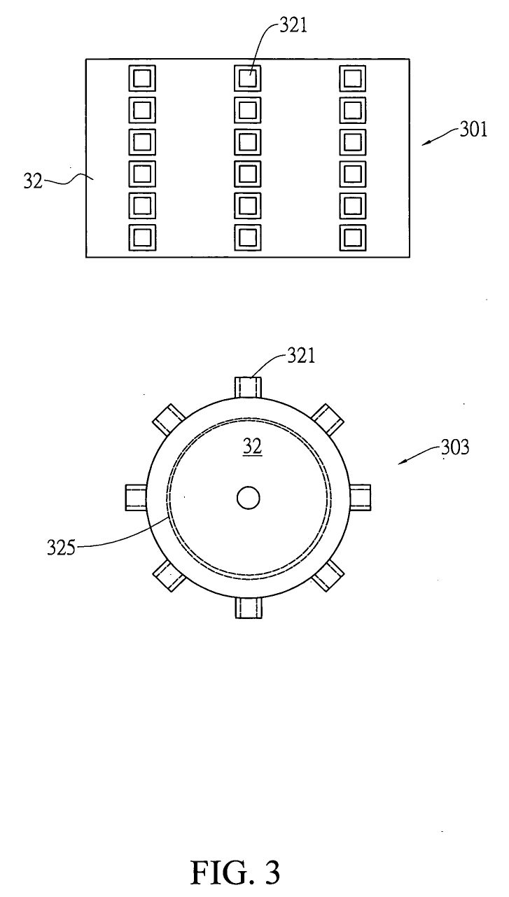

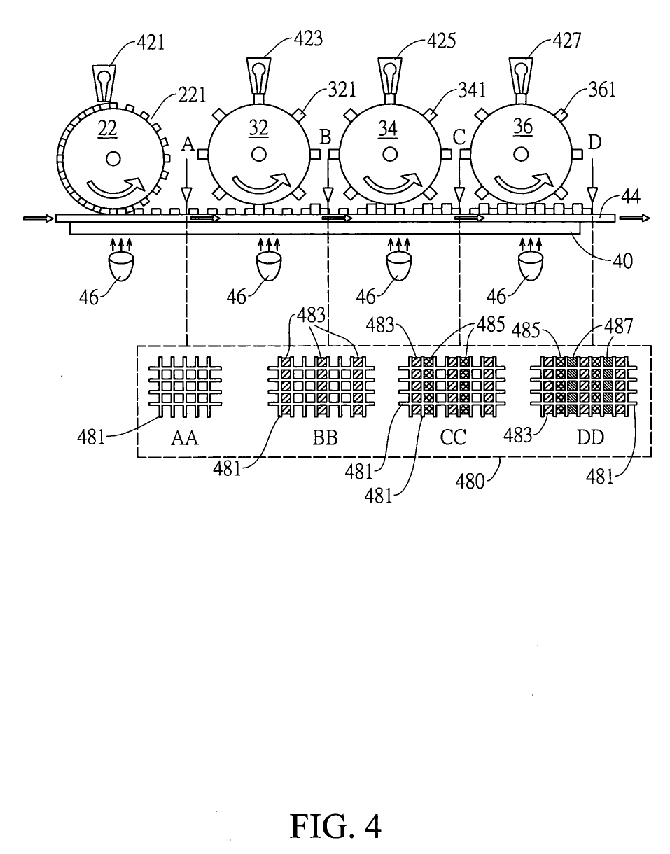

Please refer to FIGS. 2 through 4 in which FIG. 2 is a schematic drawing showing the structure of a black matrix printing roller for a color filter fabrication apparatus according to a first embodiment of the present invention; FIG. 3 is a schematic drawing showing the structure of a photoresist printing roller for a color filter fabrication apparatus according to a first embodiment of the present invention; FIG. 4 is a schematic drawing showing the arrangement of a color filter fabrication apparatus according to a first embodiment of the present invention. The present invention utilizes a roller printing technique to make black matrix, red colored negative photoresist, green colored negative photoresist and blue colored negative photoresist, improving color filter fabrication yield rate and lowering color filter manufacturing cost and material loss.

A color filter fabrication apparatus in accordance with the present invention comprises a platform 40 adapted for carrying a substrate 44 for processing, a black matrix printing roller 22, a red photoresist printing roller 32, a green photoresist printing roller 34 and a blue photoresist printing roller 36.

The black matrix printing roller 22 has a black matrix female mould 221 arranged on the cylindrical surface thereof, as shown in FIG. 2. As indicated in the extended view 201 and cross sectional view 203 in FIG. 2, the black matrix female mould 221 has longitudinal grooves and transverse grooves intersected on the cylindrical surface of the black matrix printing roller 22. The black matrix printing roller 22 further has a temperature control device 225 mounted therein for controlling the temperature of the black matrix material being applied to the black matrix printing roller 22 so as to keep the black matrix material in an optimal viscosity.

The red photoresist printing roller 32 has a red photoresist female mould 321 arranged on the cylindrical surface thereof and a temperature control device 325 mounted therein, as shown in FIG. 3. The extended view 301 and cross sectional view 303 in FIG. 3 show the structural features of the red photoresist printing roller 32. To avoid damage to the printed black matrix 481 at the substrate 44 during printing of the red photoresist printing roller 32, the red photoresist female mould 321 is made in the form of a hollow female mould protruded from the cylindrical peripheral wall of the red photoresist printing roller 32, and the red photoresist 483 is filled in the hollow inside space of the red photoresist printing roller 32 for printing onto the substrate 44 by the red photoresist printing roller 32. The temperature control device 325 is arranged near the cylindrical peripheral wall of the red photoresist printing roller 32 to control the temperature of the red photoresist in the red photoresist female mould 321.

According to this embodiment, the green photoresist printing roller 34 and the blue photoresist printing roller 36 have a structure similar to the red photoresist printing roller 32 with the exception that the green photoresist printing roller 34 has a green photoresist 485 filled in the green photoresist female mould thereof and the blue photoresist printing roller 36 has a blue photoresist 487 filled in the blue photoresist female mould thereof.

Referring to FIG. 4, after preparation of the black matrix printing roller 22, the red photoresist printing roller 32, the green photoresist printing roller 34 and the blue photoresist printing roller 36, they are arranged at respective predetermined positions relative to the platform 40, and then the prepared substrate 44 is fed into the platform 40 and moved and printed by the black matrix printing roller 22, the red photoresist printing roller 32, the green photoresist printing roller 34 and the blue photoresist printing roller 36 in a proper order.

The black matrix printing roller 22 is disposed at the frontmost side relative to the other printing rollers. A black matrix coater 421 is provided above the black matrix printing roller 22 for applying a black matrix material to the black matrix female mould 221 of the black matrix printing roller 22. The black matrix printing roller 22 touches the substrate 44, and is rotated to print the black matrix material onto the substrate 44, forming a black matrix 481 on the substrate 44. In the frame of printing pattern 480 shown in FIG. 4, AA shows the printed pattern of the black matrix 481 at point A in the color filter fabrication apparatus.

The red photoresist printing roller 32, the green photoresist printing roller 34 and the blue photoresist printing roller 36 may be arranged above the platform 40 behind the black matrix printing roller 22 at any desired order. According to this embodiment, the red photoresist printing roller 32, the green photoresist printing roller 34 and the blue photoresist printing roller 36 are arranged one after another in a proper order in a parallel manner behind the black matrix printing roller 22.

Further, a red photoresist coater 423, a green photoresist coater 425 and a blue photoresist coater 427 are respectively arranged above the red photoresist printing roller 32, the green photoresist printing roller 34 and the blue photoresist printing roller 36 for applying a red photoresist, a green photoresist and a blue photoresist to the red photoresist female mould 321, the green photoresist female mould 341 and the blue photoresist female mould 361 respectively.

After application of the red, green and blue photoresist materials to the red photoresist female mould 321, the green photoresist female mould 341 and the blue photoresist female mould 361, the red photoresist printing roller 32, the green photoresist printing roller 34 and the blue photoresist printing roller 36 are rotated to print the red photoresist 483, the green photoresist 485 and the blue photoresist 487 onto the substrate 44 in a respective area defined by the black matrix 481.

When the substrate 44 is being moved through point B, pint C and point D in the fabrication apparatus, the printed patterns BB, CC, DD are shown in the frame of printing pattern 480 in FIG. 4.

Further, curing apparatuses 46 are respectively provided below the platform 40 corresponding to the black matrix printing roller 22, the red photoresist printing roller 32, the green photoresist printing roller 34 and the blue photoresist printing roller 36 for curing the printed black matrix, red photoresist, green photoresist and blue photoresist and enhancing the effect of the adherence of the respective printed material to the substrate 44.

The curing apparatuses 46 are selected subject to the material properties of the black matrix 481, the red photoresist 483, the green photoresist 485 and the blue photoresist 487. In case the black matrix 481, the red photoresist 483, the green photoresist 485 and the blue photoresist 487 are respectively prepared from photo-curable materials, the curing apparatuses 46 can be ultraviolet light curing apparatus. If the black matrix 481, the red photoresist 483, the green photoresist 485 and the blue photoresist 487 are respectively prepared from thermoset materials, the curing apparatuses 46 can be thermosetting type curing apparatus for curing the black matrix 481, the red photoresist 483, the green photoresist 485 and the blue photoresist 487 respectively by heating.

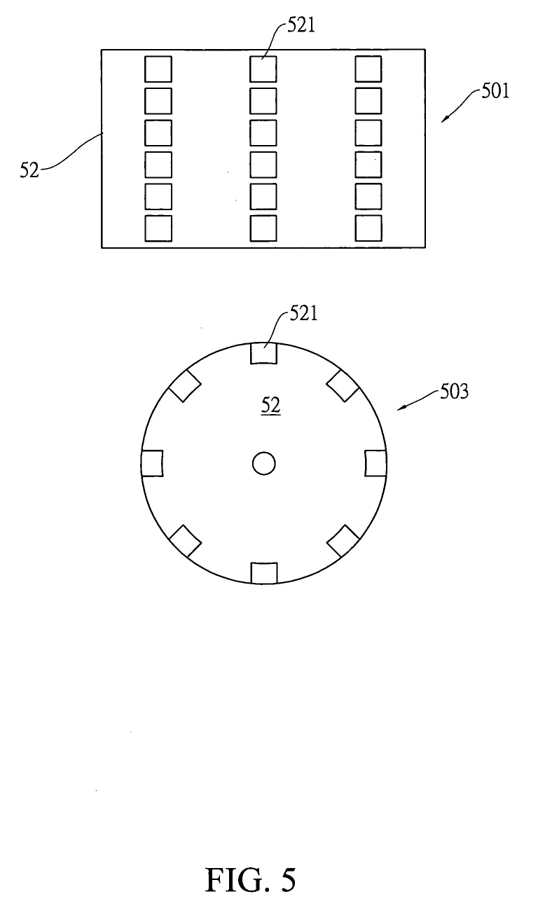

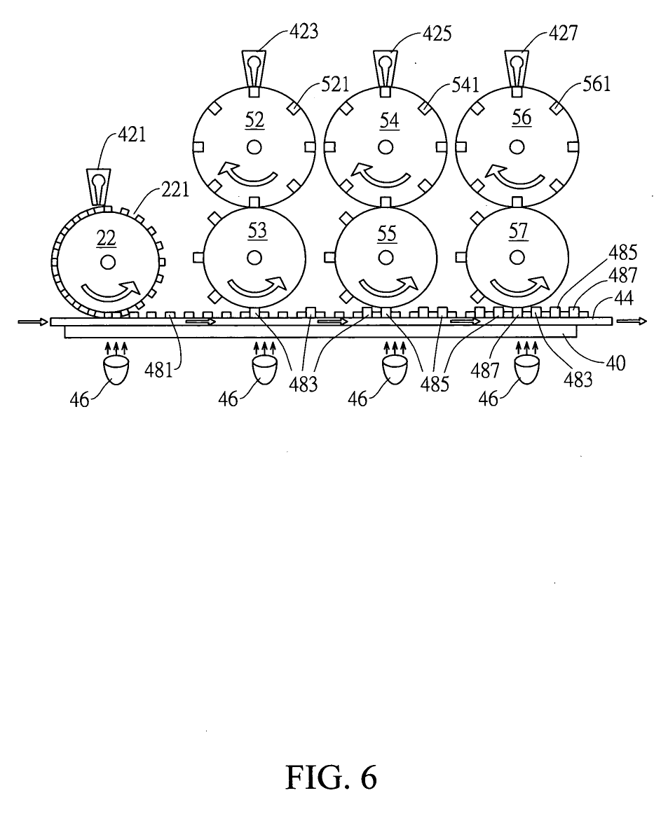

FIGS. 5 and 6 show the structure of a photoresist printing roller and a color filter fabrication apparatus in accordance with a second embodiment of the present invention. According to this second embodiment, the color filter fabrication apparatus comprises a platform 40 adapted for carrying a substrate 44 for processing, a black matrix printing roller 22, a red photoresist printing roller 52, a red transfer-printing roller 53, a green photoresist printing roller 54, a green transfer-printing roller 55, a blue photoresist printing roller 56 and a blue transfer-printing roller 57.

The red photoresist printing roller 52 has a red photoresist female mould 521 arranged on the cylindrical surface thereof as shown in FIG. 5. The extended view 501 and cross sectional view 503 in FIG. 5 show the structural features of the red photoresist printing roller 52.

This second embodiment employs a transfer-printing technique to transfer-print different photoresist materials to the substrate 44, avoiding damage to the black matrix 481. The red photoresist female mould 321 is directly formed on and curved inwards in the cylindrical surface of the red photoresist printing roller 52, facilitating filling of the red photoresist.

According to this second embodiment, the black matrix printing roller 22 is disposed at the frontmost side relative to the other printing rollers. A black matrix coater 421 is provided above the black matrix printing roller 22 for applying a black matrix material to the black matrix female mould 221 of the black matrix printing roller 22. The black matrix printing roller 22 touches the substrate 44, and is rotated to print the black matrix material onto the substrate 44.

The red transfer-printing roller 53, the green transfer-printing roller 55 and the blue transfer-printing roller 57 can be arranged above the platform 40 at predetermined locations in any desired order. Because these transfer-printing rollers are responsible for transfer printing only, they do not have any microstructure pattern on the respective cylindrical surface. The red transfer-printing roller 53, the green transfer-printing roller 55 and the blue transfer-printing roller 57 are arranged above the platform 40 for the contact of the respective photoresist materials and for transfer-printing the respective photoresist materials onto the substrate 44.

The red photoresist printing roller 52, the green photoresist printing roller 54 and the blue photoresist printing roller 56 are respectively arranged above the red transfer-printing roller 53, the green transfer-printing roller 55 and the blue transfer-printing roller 57. Further, a red photoresist coater 423, a green photoresist coater 425 and a blue photoresist coater 427 are respectively arranged above the red photoresist printing roller 52, the green photoresist printing roller 54 and the blue photoresist printing roller 56 for applying a red photoresist, a green photoresist and a blue photoresist to the red photoresist female mould 521 of the red photoresist printing roller 52, the green photoresist female mould 541 of the green photoresist printing roller 54 and the blue photoresist female mould 561 of the blue photoresist printing roller 56 respectively.

After application of the red, green and blue photoresist materials to the red photoresist female mould 521, the green photoresist female mould 541 and the blue photoresist female mould 561, the red photoresist printing roller 52, the green photoresist printing roller 54 and the blue photoresist printing roller 56 are rotated to transfer the red photoresist 483, the green photoresist 485 and the blue photoresist 487 to the red transfer-printing roller 53, the green transfer-printing roller 55 and the blue transfer-printing roller 57, and at the same time the red transfer-printing roller 53, the green transfer-printing roller 55 and the blue transfer-printing roller 57 are rotated to transfer-print the red photoresist 483, the green photoresist 485 and the blue photoresist 487 onto the substrate 44 in a respective area defined by the black matrix 481.

Further, curing apparatuses 46 are respectively provided below the platform 40 corresponding to the black matrix printing roller 22, the red transfer-printing roller 53, the green transfer-printing roller 55 and the blue transfer-printing roller 57 for curing the printed black matrix, red photoresist, green photoresist and blue photoresist and enhancing the effect of the adherence of the respective printed material to the substrate 44.

Further, in the aforesaid embodiments, the red photoresist 483, the green photoresist 485 and the blue photoresist 487 are negative photoresists; the substrate 44 can be a flexible substrate; the black matrix coater 421, the red photoresist coater 423, the green photoresist coater 425 and the blue photoresist coater 427 can be slit coaters, squeeze roll coaters or blade coaters.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A color filter fabrication apparatus, comprising:
a platform carrying a substrate;
a black matrix printing roller mounted on said platform in a first position and kept in contact with said substrate for printing a black matrix material on said substrate;
a first photoresist printing roller mounted on said platform in a second position and kept in contact with said substrate for printing a first photoresist material on said substrate;
a second photoresist printing roller mounted on said platform in a third position and kept in contact with said substrate for printing a second photoresist material on said substrate; and
a third photoresist printing roller mounted on said platform in a fourth position and kept in contact with said substrate for printing a third photoresist material on said substrate;
wherein said first photoresist printing roller, said second photoresist printing roller and said third photoresist printing roller are rotated to print said first photoresist, said second photoresist and said third photoresist onto said substrate in such a manner that the printed first photoresist, second photoresist and third photoresist fill up a respective area defined by the black matrix material being printed on said substrate by said black matrix printing roller.

2. The color filter fabrication apparatus as claimed in claim 1 wherein said black matrix printing roller has a black matrix female mould microstructure formed on a cylindrical peripheral surface thereof; said first photoresist printing roller has a first photoresist female mould microstructure formed on a cylindrical peripheral surface thereof; said second photoresist printing roller has a second photoresist female mould microstructure formed on a cylindrical peripheral surface thereof; said third photoresist printing roller has a third photoresist female mould microstructure formed on a cylindrical peripheral surface thereof.

3. The color filter fabrication apparatus as claimed in claim 1, further comprising a black matrix coater, a first photoresist coater, a second photoresist coater and a third photoresist coater respectively provided above said black matrix printing roller, said first photoresist printing roller, said second photoresist printing roller and said third photoresist printing roller for applying a black matrix material, a first photoresist material, a second photoresist material and a third photoresist material to said black matrix printing roller, said first photoresist printing roller, said second photoresist printing roller and said third photoresist printing roller respectively.

4. The color filter fabrication apparatus as claimed in claim 1, further comprising a plurality of curing apparatus respectively disposed below said platform corresponding to said black matrix printing roller, said first photoresist printing roller, said second photoresist printing roller and said third photoresist printing roller for curing the materials printed onto said substrate by said black matrix printing roller, said first photoresist printing roller, said second photoresist printing roller and said third photoresist printing roller respectively.

5. The color filter fabrication apparatus as claimed in claim 1 wherein said first photoresist material, said second photoresist material and said third photoresist material are red negative photoresist, green negative photoresist and blue negative photoresist respectively.

6. The color filter fabrication apparatus as claimed in claim 4, wherein said black matrix material, said first photoresist material, said second photoresist material and said third photoresist material are respectively selected from one of photo-curable materials or thermoset materials.

7. The color filter fabrication apparatus as claimed in claim 6, wherein said curing apparatus are respectively selected from one of photo-curable type or thermosetting type curing apparatuses subject to the material properties of said black matrix material, said first photoresist material, said second photoresist material and said third photoresist material.

8. The color filter fabrication apparatus as claimed in claim 7, wherein said photo-curable type curing apparatuses are ultraviolet light curing apparatuses.

9. The color filter fabrication apparatus as claimed in claim 7, wherein said thermosetting type curing apparatus are adapted to cure the respective materials by heating.

10. The color filter fabrication apparatus as claimed in claim 3, wherein said black matrix coater, said first photoresist coater, said second photoresist coater and said third photoresist coater are respectively selected from one of slit coaters, squeeze roll coaters and blade coaters.

11. The color filter fabrication apparatus as claimed in claim 1, wherein said substrate is a flexible substrate.

12. The color filter fabrication apparatus as claimed in claim 1, wherein said black matrix printing roller, said first photoresist printing roller, said second photoresist printing roller and said third photoresist printing roller each have a respective temperature control device mounted therein.

13. A color filter fabrication apparatus, comprising:
a platform carrying a substrate;
a black matrix printing roller mounted on said platform in a first position and kept in contact with said substrate for printing a black matrix material on said substrate;
a first transfer-printing roller mounted on said platform in a second position and kept in contact with said substrate for transfer-printing a first photoresist material on said substrate;
a first photoresist printing roller disposed above said first transfer-printing roller for printing a first photoresist material onto said first transfer-printing roller;
a second transfer-printing roller mounted on said platform in a third position and kept in contact with said substrate for printing a second photoresist material on said substrate;
a second photoresist printing roller disposed above said second transfer-printing roller for printing a second photoresist material onto said second transfer-printing roller;
a third transfer-printing roller mounted on said platform in a fourth position and kept in contact with said substrate for printing a third photoresist material on said substrate; and
a third photoresist printing roller disposed above said third transfer-printing roller for printing a third photoresist material onto said third transfer-printing roller;
wherein said first transfer-printing roller, said second transfer-printing roller and said third transfer-printing roller are rotated to print said first photoresist, said second photoresist and said third photoresist onto said substrate in such a manner that the printed first photoresist, second photoresist and third photoresist fill up a respective area defined by the black matrix material being printed on said substrate by said black matrix printing roller.

14. The color filter fabrication apparatus as claimed in claim 13, wherein said black matrix printing roller has a black matrix female mould microstructure formed on a cylindrical peripheral surface thereof; said first photoresist printing roller has a first photoresist female mould microstructure formed on a cylindrical peripheral surface thereof; said second photoresist printing roller has a second photoresist female mould microstructure formed on a cylindrical peripheral surface thereof; said third photoresist printing roller has a third photoresist female mould microstructure formed on a cylindrical peripheral surface thereof.

15. The color filter fabrication apparatus as claimed in claim 13, further comprising a black matrix coater, a first photoresist coater, a second photoresist coater and a third photoresist coater respectively provided above said black matrix printing roller, said first photoresist printing roller, said second photoresist printing roller and said third photoresist printing roller for applying a black matrix material, a first photoresist material, a second photoresist material and a third photoresist material to said black matrix printing roller, said first photoresist printing roller, said second photoresist printing roller and said third photoresist printing roller respectively.

16. The color filter fabrication apparatus as claimed in claim 13, further comprising a plurality of curing apparatus respectively disposed below said platform corresponding to said black matrix printing roller, said first photoresist transfer-printing roller, said second photoresist transfer-printing roller and said third photoresist transfer-printing roller for curing the materials printed onto said substrate by said black matrix printing roller, said first photoresist transfer-printing roller, said second photoresist transfer-printing roller and said third photoresist transfer-printing roller respectively.

17. The color filter fabrication apparatus as claimed in claim 13 wherein said first photoresist material, said second photoresist material and said third photoresist material are red negative photoresist, green negative photoresist and blue negative photoresist respectively.

18. The color filter fabrication apparatus as claimed in claim 16, wherein said black matrix material, said first photoresist material, said second photoresist material and said third photoresist material are respectively selected from one of photo-curable materials or thermoset materials.

19. The color filter fabrication apparatus as claimed in claim 18, wherein said curing apparatus are respectively selected from one of photo-curable type or thermosetting type curing apparatuses subject to the material properties of said black matrix material, said first photoresist material, said second photoresist material and said third photoresist material.

20. The color filter fabrication apparatus as claimed in claim 19, wherein said photo-curable type curing apparatuses are ultraviolet light curing apparatuses.

21. The color filter fabrication apparatus as claimed in claim 19, wherein said thermosetting type curing apparatus are adapted to cure the respective materials by heating.

22. The color filter fabrication apparatus as claimed in claim 15, wherein said black matrix coater, said first photoresist coater, said second photoresist coater and said third photoresist coater are respectively selected from one of slit coaters, squeeze roll coaters and blade coaters.

23. The color filter fabrication apparatus as claimed in claim 13, wherein said substrate is a flexible substrate.

24. The color filter fabrication apparatus as claimed in claim 13, wherein said black matrix printing roller, said first photoresist printing roller, said second photoresist printing roller, said third photoresist printing roller, said first transfer-printing roller, said second transfer-printing roller and said third transfer-printing roller each have a respective temperature control device mounted therein.
